(19) United States
(12) Patent Application Publication
(10) Pub. No.: US 2026/0316315 A1
(43) Pub. Date: Oct. 15, 2026

(54) Chunk-Cutter Machine

(71) Applicant: Accella Polyurethane Systems LLC, Maryland Heights, MO (US)

(72) Inventor: Jeff Little, Rossville, GA (US)

(21) Appl. No.: 19/639,344

(22) Filed: Apr. 6, 2026

Related U.S. Application Data
(60) Provisional application No. 63/788,327, filed on Apr. 14, 2025.

(51) Int. Cl. B26D 3/00; B29B 17/04; B29K 75/00; B29K 105/04; B29K 105/26

(52) U.S. Cl. CPC B26D 3/006; B29B 17/0412; B29B 2017/044; B29K 2075/00; B29K 2105/04; B29K 2105/26

(57) ABSTRACT

The polyurethane foam that forms the core of the foam-filled tires needs proper disposal or recycling once the tire has run its course. Instead of landfilling the tire-fill, which is for example, the TyrFil® type PU material, the present invention, in one embodiment relates to shredding the foam into chunks that can then be used for other applications. More specifically, in its one embodiment, the present invention relates to a chunk-cutting machine and in another embodiment, a process for chunk-cutting the PU foam material waste from the foam-filled tires. These and other embodiments are described infra.

### CROSS REFERENCE TO RELATED APPLICATIONS

The present application hereby claims the benefit of the provisional patent application of the same title, Ser. No. 63/788,327, filed on Apr. 14, 2025, the disclosure of which is herein incorporated by reference in its entirety.

### BACKGROUND

Tire purchase and maintenance are some of the more significant expenses that heavy equipment owners and fleet managers must consider. Tire options for Off-the-Road (OTR) heavy equipment include: pneumatic tires, solid-aperture tires, and elastomer or foam-fill tires. This disclosure relates to such elastomer-filled tires which are filled-pneumatics with elastomeric polyurethane materials such as TyrFil® flat-proofing.

The elastomeric-filled tires include a polyurethane liquid such as TyrFil® flat-proofing, which is pumped into OTR tires, replacing all of the air, and curing into a solid elastomer within 24-48 hours. The advantage of the foam-filled tires is, even in the most hazardous environments, tires filled with elastomeric PU material such as TyrFil® will never go flat.

Elastomer-filled tires offer advantages including maintaining optimal tire pressure, providing consistent tire deflection and footprint, and increasing traction and stability. Unlike solid or aperture tires, elastomer-filled tires filled with foams such as TyrFil® offer a choice when it comes to pressure, durometer and tire tread. Stated differently, the OTR operator is able to use the exact tire originally specified by the manufacturer and allows the operator to customize performance according to the application or the environment.

Pneumatic tires offer various cost advantages, but are vulnerable to going flat from nails, screws, and rebar punctures and are more prone to dangerous blowouts. You are more likely to experience premature tire failure due to flats and blowouts. Also, tire flats are not only dangerous to field operators, but they are also costly, as they drain resources, affect the work schedule, decrease on-the-job productivity, and may render serious damage to equipment. Solid tires are composed of the most stable tire material on the market and cannot be punctured. However, they are limited on sizes, tread patterns, and durometers, and their ride may be rougher for equipment operators. Solid tires also represent a potentially negative impact on the environment, as they cannot be reclaimed as easily as polyurethane-filled tires. Mounting equipment for solid tires is expensive, and the areas around the holes in aperture tires may be more prone to cracking. That increases tire wear and hastens the end of the tire life cycle. Elastomer-fill or foam-fill eases this risk, helping to extend tire usability and saving operators from incurring costly equipment damage expenses.

Elastomer or foam-filled tires essentially offer most of the same benefits a set of pneumatic tires do, with the clear distinction of not experiencing leakage through punctures and tears. Over time, all air-filled pneumatic tires are going to lose air—an issue an operator will not face with elastomer- or foam-filled tires. Also, the tire fill pressure can be varied to more closely mimic pneumatic tire pressure. TyrFil® is a polyurethane liquid that is pumped into pneumatic tires to replace air with a resilient, synthetic elastomer core that eliminates dangerous and costly tire flats on off-the-road (OTR) equipment. Generally speaking, even in the most hazardous environments, tires filled with TyrFil™ will never go flat. Despite cuts and punctures, elastomer-filled tires will keep performing—increasing productivity and eliminating costly downtime for field operators.

For example, TyrFil®, a well-known brand of tire-fill material, is a polyurethane liquid pumped into pneumatic tires to replace air with a resilient, synthetic elastomer core. The polyurethane liquid cures into a solid, flexible core, acting as a shock absorber and eliminating the possibility of flat tires. Benefits include elimination of flats as the PU elastomeric foam-filled tires do not deflate or go flat, even with punctures. Another advantage is the improvement in traction and stability because the solid core provides consistent tire deflection and footprint. The flexible core absorbs shocks, resulting in a smoother ride compared to solid tires. Foam or elastomer-filled tires can be a more cost-effective solution compared to solid tires or other flat-proofing methods. Foam or elastomer-filled tires are commonly used in industrial and heavy equipment, particularly in environments with high puncture hazards, such as off-the-road vehicles and forklifts.

The greatest advantage of TyrFil® over other No-Flat options, including solid aperture tires, is the smoother ride as a result of a substantially lower G-force transmission. Higher G-force transmission can cause operator injury and premature wear and tear on equipment components, and it is the leading cause of Whole-Body Vibration (WBV). The physiological effect may result in worker attrition and job absence due to measurable muscular-skeletal and neurological injury to equipment operators. This is a serious occupational hazard, not to be ignored, that can cost construction companies hundreds of thousands of dollars in damages.

The polyurethane foam that forms the core of the foam-filled tires needs proper disposal or recycling once the tire has run its course. Instead of landfilling the tire-fill, which is for example, the TyrFil® type PU material, the present invention, in one embodiment relates to shredding the foam into chunks that can then be used for other applications. More specifically, in its one embodiment, the present invention relates to a chunk-cutting machine and in another embodiment, a process for chunk-cutting the PU foam material waste from the foam-filled tires. These and other embodiments are described infra.

### BRIEF SUMMARY

In some embodiments, a chunk-cutter machine for cutting polymeric material, as described in this document, comprises:
(a) a planar first blade for cutting a portion of the polymeric material fed to the chunk-cutter machine;
(b) a first plunger arm actuatably connected to the planar first blade;
(c) a blade assembly for cutting the portion of the polymeric material into a plurality of three-dimensional chunks, wherein the blade assembly is removably inserted into the blade-assembly slot of the chunk-cutter machine;
(d) a three-dimensional hydraulic ram, dimensionally compatible with the blade assembly such that the hydraulic ram can trap and press the portion of polymeric material for cutting the polymeric material through the plurality of blades of the blade assembly;
(e) a second plunger actuatably connected to the hydraulic ram, which can actuate movement of the hydraulic ram; and
(f) a hydraulic machinery means for actuating at least the hydraulic ram actuatably connected to the second plunger.

In some embodiments, a chunk-cutter machine as recited above, wherein the polymeric material is an elastomeric polymeric material.

In some embodiments, a chunk-cutter machine as recited above, wherein the elastomeric polymeric material is a tire-fill material.

In some embodiments, a chunk-cutter machine as recited above, wherein the tire fill material for cutting obtained from used tires, unused tires, or other waste or non-waste material from tire-fill production.

In some embodiments, a chunk-cutter machine as recited above, wherein the tire-fill material is for or from tires of off-the-road and heavy-duty equipment.

In some embodiments, a chunk-cutter machine as recited above, wherein the tire-fill material is for or from tires usable for the following equipment:
articulating boom aerial platforms; backhoes; baggage carts; carry-deck cranes; compact utility loaders; concrete buggies; forklifts; front-end loaders; GSE pushback tractors; mobile cranes; mowing equipment; personnel carriers; rough-terrain forklifts; scissor-lift aerial platforms; scoops; skid steers; shuttle cars; sweepers; tractors; trucks; telescopic aerial platforms; telehandler; trenchers; and wheel loaders.

In some embodiments, a chunk-cutter machine as recited above, wherein the polymeric material is polyurethane material, its blends, its copolymers, and mixtures thereof.

In some embodiments, a chunk-cutter machine as recited above, wherein the tire-fill material is the commercially available TyrFil® material.

In some embodiments, a chunk-cutter machine as recited above, further comprising a hopper for gravity-feeding or pressure-feeding the polymeric material.

In some embodiments, a chunk-cutter machine as recited above, wherein the hopper is a vertically-oriented hopper.

In some embodiments, a chunk-cutter machine as recited above, wherein the planar first blade is capable of moving in a horizontal plane.

In some embodiments, a chunk-cutter machine as recited above, wherein the planar first blade is capable of moving in a nonhorizontal plane or in two or more different planes consecutively.

In some embodiments, a chunk-cutter machine as recited above, wherein the planar first blade has a constant cutting speed.

In some embodiments, a chunk-cutter machine as recited above, wherein the planar first blade has a variable cutting speed or can move in a to-and-fro motion at a steady speed or at a variable speed.

In some embodiments, a chunk-cutter machine as recited above, wherein the blade assembly is vertically-oriented.

In some embodiments, a chunk-cutter machine as recited above, wherein the blade assembly is inserted from the side of the machine.

In some embodiments, a chunk-cutter machine as recited above, wherein the blade assembly is comprised of cube-shaped slots that can cut a plurality of three-dimensional cube-shaped polymeric material chunks from the polymeric material feed.

In some embodiments, a chunk-cutter machine as recited above, wherein any one dimension of a chunk in the plurality of three-dimensional chunks is in the range of 1 cm to 30 cm.

In some embodiments, a chunk-cutter machine as recited above, wherein the dimension of hydraulic ram's face used for pressurizing the portion of the polymeric material for cutting, is substantially equal to or bigger than the size of the inner face of the blade assembly.

In some embodiments, a chunk-cutter machine as recited above, wherein the hydraulic ram is three-dimensionally oriented in its shape.

In some embodiments, a chunk-cutter machine as recited above, wherein the hydraulic ram is predominantly two-dimensional a platen, with its third-dimension perpendicular to the blade but only having a nominal width compared to the other two dimensions of the platen.

In some embodiments, a chunk-cutter machine as recited above, wherein the hydraulic ram is capable of moving at a steady speed, at a variable speed, or in a to-and-fro motion, which can be steady or variable speed.

In some embodiments, a chunk-cutter machine as recited above, wherein the blade assembly has circular pattern to generate cylindrical-shaped plurality of polymeric material chunks, or other patterns such as five sided cylinders, six sided cylinders, or other common geometric shapes.

In some embodiments, a method for preparing polymeric material chunks using a chunk-cutter machine as described above, comprising providing polymeric material to the chunk-cutter machine, cutting a portion of the polymeric material, cutting such the portion of the polymeric material into a plurality of chunks of a desired shape as recited supra.

In some embodiments, a method for preparing polymeric material chunks using the chunk-cutter machine as recited above, wherein the polymeric material for cutting is from used tires, unused tires, or other waste or non-waste material.

In some embodiments, a method for preparing polymeric material chunks using the chunk-cutter machine as recited above, wherein the polymeric material is polyurethane material.

In some embodiments, a method for preparing polymeric material chunks using the chunk-cutter machine as recited above, wherein the polymeric material is the commercially available TyrFil® material.

In some embodiments, a method for preparing polymeric material chunks using the chunk-cutter machine as recited above, further comprising a hopper for gravity feeding a polymeric material.

In some embodiments, a method for preparing polymeric material chunks using the chunk-cutter machine as recited above, wherein the hopper is a vertically-oriented hopper. In some embodiments, a method for preparing polymeric material chunks using the chunk-cutter machine as recited above, wherein the planar first blade is in a horizontal plane.

In some embodiments, a method for preparing polymeric material chunks using the chunk-cutter machine as recited above, wherein the planar first blade is not in a horizontal plane.

In some embodiments, a method for preparing polymeric material chunks using the chunk-cutter machine as recited above, wherein the planar first blade has a constant cutting speed.

In some embodiments, a method for preparing polymeric material chunks using the chunk-cutter machine as recited above, wherein the planar first blade has a variable cutting speed or can move in a to-and-fro motion at a steady speed or at a variable speed.

In some embodiments, a method for preparing polymeric material chunks using the chunk-cutter machine as recited above, wherein the blade assembly is vertically-oriented.

In some embodiments, a method for preparing polymeric material chunks using the chunk-cutter machine as recited above, wherein the blade assembly is inserted from the side of the machine.

In some embodiments, a method for preparing polymeric material chunks using the chunk-cutter machine as recited above, wherein the blade assembly is comprises of cube-shaped slots that can cut a plurality of three-dimensional cube-shaped polymeric material chunks from the polymeric material feed.

In some embodiments, a method for preparing polymeric material chunks using the chunk-cutter machine as recited above, wherein any one dimension of a chunk in the plurality of three-dimensional chunks is in the range of 1 cm to 30 cm.

In some embodiments, a method for preparing polymeric material chunks using the chunk-cutter machine as recited above, wherein the hydraulic ram in its dimension of its face used for pressing the portion of the polymeric materials for cutting, is comparable to size of the inner face of the blade assembly.

In some embodiments, a method for preparing polymeric material chunks using the chunk-cutter machine as recited above, wherein the hydraulic ram is three-dimensionally oriented.

In one some embodiments, a method for preparing polymeric material chunks using the chunk-cutter machine as recited above, wherein the hydraulic ram is predominantly two-dimensional a platen, with its third-dimension perpendicular to the blade but only with a nominal width compared to the other two dimensions of the platen.

In some embodiments, a method for preparing polymeric material chunks using the chunk-cutter machine as recited above, wherein the hydraulic ram is capable of moving at a steady speed, at a variable speed, or in a to-and-fro motion, which can be steady or variable speed.

In some embodiments, a method for preparing polymeric material chunks using the chunk-cutter machine as recited above, wherein the blade assembly has circular pattern to generate cylindrical-shaped plurality of polymeric material chunks, or other patterns such as a prism, a pentagon shape, a hexagon shape, and other common geometric shapes.

In some embodiments, a method for preparing polymeric material chunks using the chunk-cutter machine as recited above, wherein the tire-fill material is for or from tires of off-the-road and heavy-duty equipment.

In some embodiments, a method for preparing polymeric material chunks using the chunk-cutter machine as recited above, wherein the tire-fill material is for or from tires usable for the following equipment: articulating boom aerial platforms; backhoes; baggage carts; carry-deck cranes; compact utility loaders; concrete buggies; forklifts; front-end loaders; GSE pushback tractors; mobile cranes; mowing equipment; personnel carriers; rough-terrain forklifts; scissor-lift aerial platforms; scoops; skid steers; shuttle cars; sweepers; tractors; trucks; telescopic aerial platforms; telehandler; trenchers; and wheel loaders.

In some embodiments, the chunk-cutter machine for cutting polymeric material, comprises: (a) a planar first blade for cutting a portion of the polymeric material fed to the chunk-cutter machine; (b) a first plunger arm actuatably connected to the planar first blade; (c) a blade assembly for cutting the portion of the polymeric material into a plurality of three-dimensional chunks; (d) a hydraulic ram, dimensionally compatible with the blade assembly such that the hydraulic ram can trap and press the portion of polymeric material for cutting through the plurality of blades of the blade assembly; and (e) a second plunger actuatably connected to the hydraulic ram, which can actuate movement of the hydraulic ram.

These and other objects and advantages shall be made apparent from the accompanying drawings and the description thereof.

### BRIEF DESCRIPTION OF THE FIGURES

The accompanying drawings, which are incorporated in and constitute a part of this specification, illustrate embodiments, and together with the general description given above, and the detailed description of the embodiments given below, serve to explain the principles of the present disclosure.

FIG. 1 shows an embodiment of the chunk-cutter machine as viewed from the front.

FIG. 2 shows an embodiment of the chunk-cutter machine from a perspective view.

FIG. 3 shows an embodiment of the chunk-cutter machine in its cross-sectional side view.

FIG. 4 shows a cross-sectional perspective view of the chunk-cutter machine in an embodiment.

FIG. 5 shows an embodiment of a doughnut shaped tire-fill from an OTR vehicle's tire.

FIG. 6 shows a front view of the chunk-cutter machine in an embodiment, before the polymeric material is cut by the first blade in a horizontal plane.

FIG. 7 shows a front view of the chunk-cutter machine in an embodiment, after the portion of the polymeric material is cut by the first blade in a horizontal plane.

FIG. 8 shows the front view of the chunk-cutter machine in an embodiment, where the freshly cut portion of the polymeric material is shown prior to it being cut into further chunks by hydraulic pressing.

FIG. 9 shows the cut chunks of the polymeric material when its precursor, the tire-fill doughnut is subjected to the chunk-cutter machine.

### DETAILED DESCRIPTION

The polyurethane elastomer that forms the core of the foam-filled tires needs proper disposal or recycling once the tire has run its course. Instead of landfilling the tire-fill type material, for example, TyrFil® polyurethane (PU) elastomeric material, the present invention, in one embodiment relates to shredding the elastomeric material into chunks that can then be used for other applications. More specifically, in its one aspect, the present invention relates to a chunk-cutting machine and in another aspect, a process for chunk-cutting polymeric materials, such as a PU elastomeric foam material waste from the elastomeric foam-filled tires. These and other embodiments of the invention are described infra.

Before the present compositions, articles, devices, and/or methods are disclosed and described, it is to be understood that the aspects described below are not limited to specific methods as such may, of course, vary. It is also to be understood that the terminology used herein is for the purpose of describing particular aspects only and is not intended to be limiting. As used in the specification and in the claims, the term “comprising” may include the embodiments “consisting of” and “consisting essentially of.”

Disclosed are materials, compositions, and components that can be used for, can be used in conjunction with, can be used in preparation for, or are products of the disclosed method and compositions. These and other materials are disclosed herein, and it is understood that when combinations, subsets, interactions, groups, and the like of these materials are disclosed that while specific reference of each various individual and collective combinations and permutation of these compounds cannot be explicitly disclosed, each is specifically contemplated and described herein. Thus, if a class of adhesives A, B, and C are disclosed as well as a class of additives D, E, and F and an example of a combination A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, compositions, and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

Unless expressly stated otherwise, it is not intended that any method outlined herein be construed as requiring that its steps be performed in a particular order. Accordingly, where a method claim does not expressly recite an order to be followed by its steps, or where neither the claims nor the descriptions specifically state that the steps are to be limited to a precise sequence, it should not be inferred that a specific order is intended or required. This holds for any possible non-express basis for interpretation, including, but not limited to logical flow or arrangement of steps; interpretations derived from the grammatical organization, syntax, or punctuation; and the quantity or variety of embodiments detailed in the specification. The description of the disclosure should not be read as mandating a fixed sequence of steps, unless such a requirement is articulated explicitly.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, a., are by weight. Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed. Where present, all ranges are inclusive and combinable. That is, references to values stated in ranges include every value within that range. For example, a range defined as from 400 to 450 ppm includes 400 ppm and 450 ppm as independent embodiments. Ranges of 400 to 450 ppm and 450 to 500 ppm may be combined to be a range of 400 to 500 ppm.

Unless stated otherwise, pressures expressed in psi units would be gauge, and pressures expressed in kPa units would be absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an endpoint of a range, the disclosure should be understood to include the specific value or endpoint referred to. When used to modify a single number, the term “about” may refer to plus or minus 10% of the indicated number and includes the indicated number. For example, “about 10%” may indicate a range of 9% to 11%, and “about 1” means from 0.9 to 1.1.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of.”

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise. As used in the specification and the appended claims, the singular forms “a,” “an,” and “the” include plural referents unless the context clearly dictates otherwise.

The term “predominant portion” or “predominantly,” as used herein, unless otherwise defined herein, means greater than 50% of the referenced material. If not specified, the percent is on a molar basis when reference is made to a molecule (such as hydrogen and ethylene) and otherwise is on a weight basis (such as for additive content).

The term “substantial portion” or “substantially,” as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

All parts, percentages and ratios used herein are expressed by weight unless otherwise specified.

In this specification and in the claims which follow, reference will be made to a number of terms which shall be defined herein.

“Optional” or “optionally” means that the subsequently described event or circumstance can or cannot occur, and that the description includes instances where the event or circumstance occurs and instances where it does not.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification. Throughout this application, various publications are referenced. The disclosures of these publications in their entireties are hereby incorporated by reference into this application in order to more fully describe the state of the art to which they pertain. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation. In the context of the present description, all publications, patent applications, patents and other references mentioned herein, if not otherwise indicated, are explicitly incorporated by reference herein in their entirety for all purposes as if fully set forth.

### The Chunk-Cutter Machine

In some embodiments, a chunk-cutter machine for cutting polymeric material, as described herein, comprising:
(a) a planar first blade for cutting a portion of the polymeric material;
(b) a first plunger arm actuatably connected to the planar first blade;
(c) a removably inserted blade assembly for cutting the portion of the polymeric material into a plurality of three-dimensional chunks, wherein the blade assembly is removably inserted into the blade-assembly slot of the chunk-cutter machine;
(d) a three-dimensional hydraulic ram dimensionally compatible with the blade assembly such that the hydraulic ram can trap and press the portion of polymeric material for cutting the polymeric material through the plurality of blades of the blade assembly;
(e) a second plunger actuatably connected to the hydraulic ram, which can actuate movement of the hydraulic ram; and
(f) a hydraulic machinery means for actuating at least the hydraulic ram actuatably connected to the second plunger.

In some embodiments, the chunk-cutter machine for cutting polymeric material, comprises: (a) a planar first blade for cutting a portion of the polymeric material fed to the chunk-cutter machine; (b) a first plunger arm actuatably connected to the planar first blade; (c) a blade assembly for cutting the portion of the polymeric material into a plurality of three-dimensional chunks; (d) a hydraulic ram, dimensionally compatible with the blade assembly such that the hydraulic ram can trap and press the portion of polymeric material for cutting through the plurality of blades of the blade assembly; and (e) a second plunger actuatably connected to the hydraulic ram, which can actuate movement of the hydraulic ram.

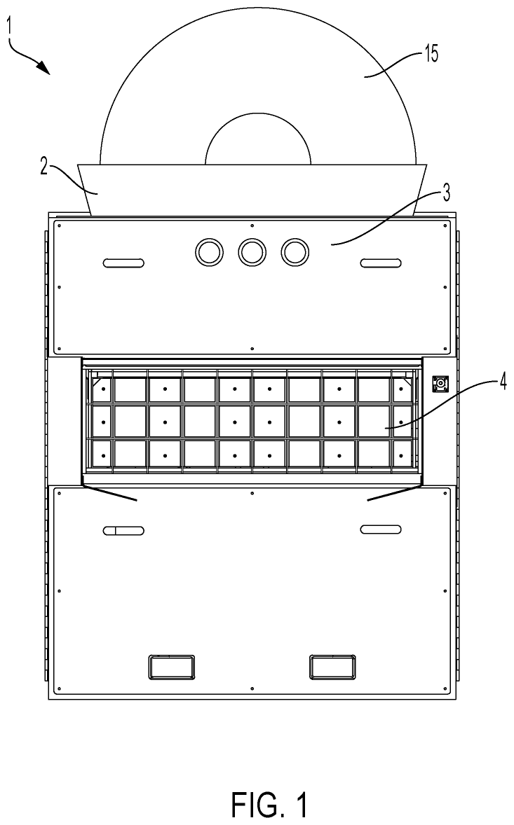

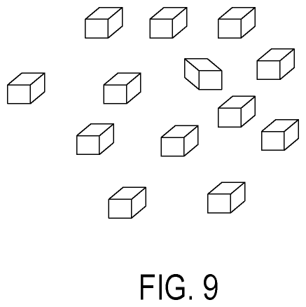

The present disclosure can be further understood from the description infra of FIGS. 1-9.

FIG. 1 shows an embodiment of the chunk-cutter machine (1) as viewed from the front. At its top, it comprises of a hopper (2) in which the polymeric material (15) such as a tire-fill is fed for subsequent cutting. The tire-fill, for example a polyurethane based elastomeric material, is shown in a tire shape (15), which was used for the inside of a tire, for example, an OTR equipment tire. The hopper (2) is gravity-fed, but in another embodiment, the feeding mechanism can be adjusted for press-feeding the tire-fill material. While it is not shown in the figure, an operator can use a small crane, a loading machine, or such device to load the tire-fill. The hopper can also be manually loaded. Below the hopper is the one of the control panels (3) for operating the machine. Below the control panel is the blade assembly port for loading the blade assembly (4) of choice. FIG. 1 also shows the blade assembly (4) with cuboid-shaped blades.

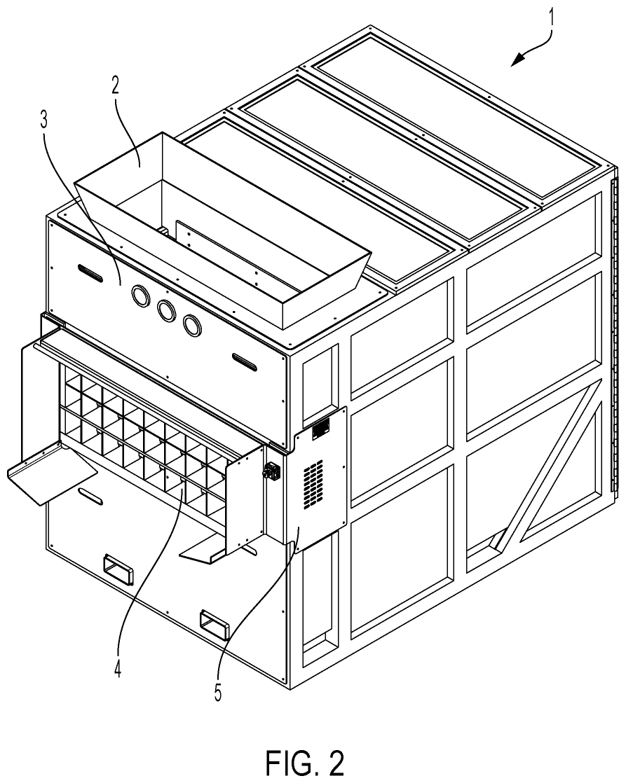

FIG. 2 shows an embodiment of the chunk-cutter machine from a perspective view. The hopper (2), the display panel for controls (3), and the blade assembly port (5) and the blade assembly (4).

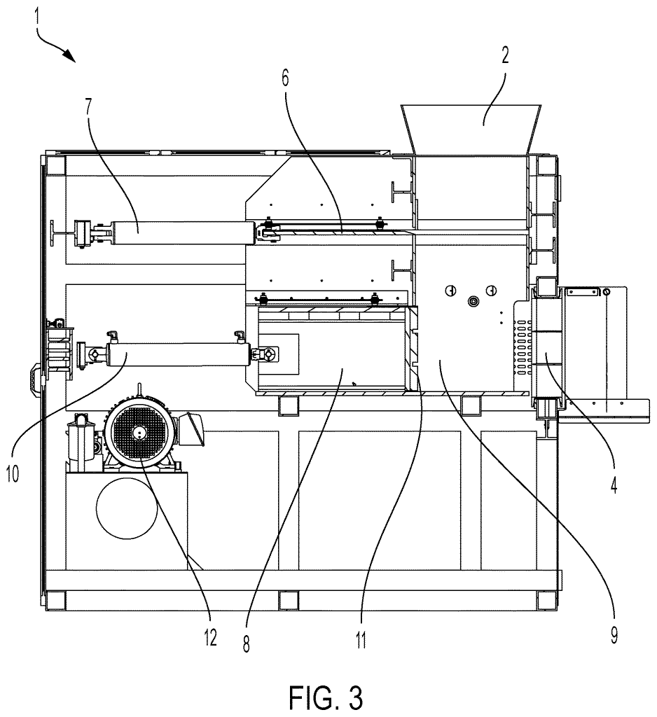

FIG. 3 an embodiment of the chunk-cutter machine in a cross-sectional side view. The feed hopper (2) is seen at the top. Below the feed hopper is shown a first planar blade (6) in horizontal orientation. That first planar blade (6) is attached to a first plunger (7) that can be actuated by hydraulic or other means to move it into a direction away from the first plunger and back to the plunger.

As the polymeric material, such as an elastomeric polyurethan, is fed into the hopper (2), the first blade can move in its planar direction, that is, generally perpendicularly to the feeding direction of the polymeric material, such that a portion of the polymeric material is cut. The portion of the polymeric material falls below the first blade (6) and into a chamber (9) or a container, or a cavity that is located in between the hydraulic ram (8) and the blade complex or the blade assembly (4). The hydraulic ram (8) is attached to a second plunger (10) that can be actuated by hydraulic or other means to move it into a direction towards the blade assembly (4) and away from the blade assembly.

It should be noted that the hydraulic ram's front face or platen (11) forms the first of the four walls of this chamber (9), and the blade assembly forms (4) a second wall of this chamber. These first and second walls are opposite walls of the cavity as shown in FIG. 3. These two walls are functional, in that, the movement of the hydraulic ram platen (11) or the first wall towards the second wall is used to press and crush the portion of the polymeric material in the chamber (9) or the cavity to force them through the cuboid-shaped blade assembly (4), which can be seen in the cross-sectional side view of FIG. 3. The hydraulic ram (8) is actuated by a second plunger (10) that is attached to the other end of the hydraulic ram (8). And at the other end of the second plunger (10) is attached the machinery means (12) to actuate the hydraulic mechanism. In some embodiments, the hydraulic ram moves in the horizontal direction, that is, generally perpendicular to the plane of the blade assembly.

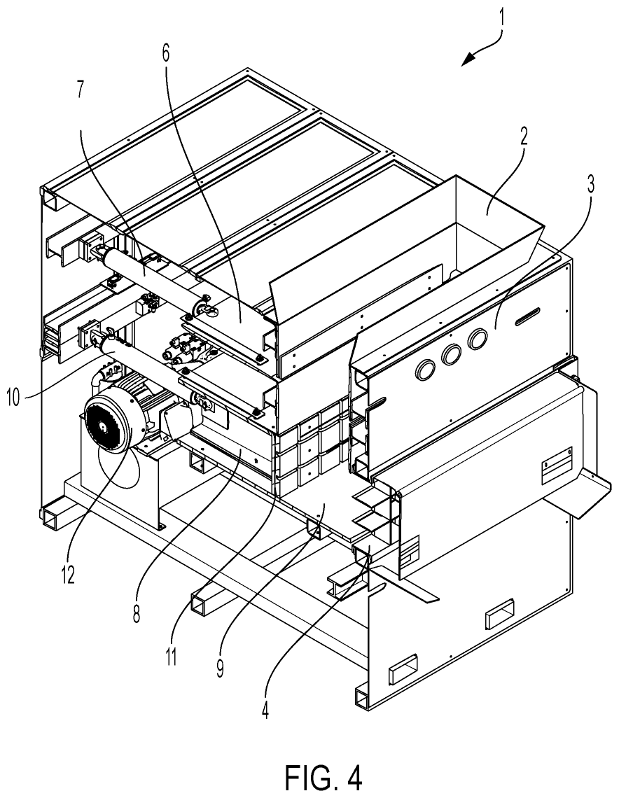

FIG. 4 shows a cross-sectional perspective view of the chunk-cutter machine (1) in an embodiment. The hopper (2) for the polymeric material, the horizontally-oriented and movable first blade (6) and its plunger (7), the hydraulic ram (8), the second plunger (10) attached to the hydraulic ram (8), the hydraulic mechanism (12), and the blade assembly (4) are also shown with clarity in FIG. 4.

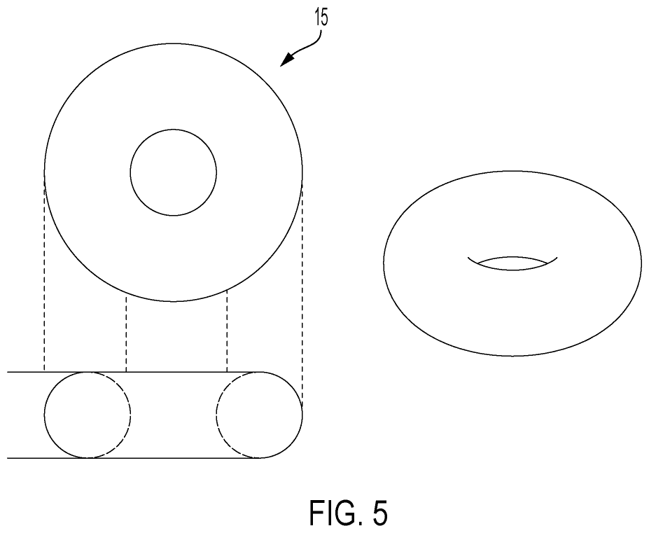

FIG. 5 shows an embodiment of a doughnut shaped polymeric material (15) which is tire-fill from an OTR vehicle's tire. In one embodiment, the tire-fill is an elastomeric polyurethane material.

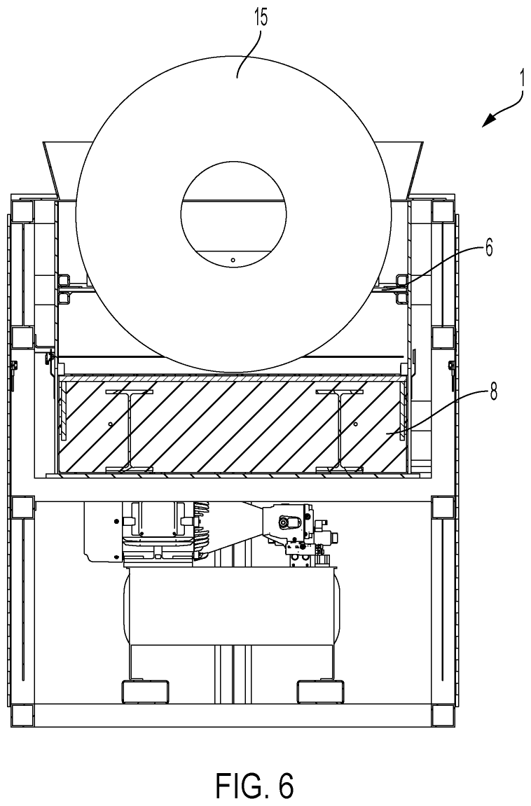

FIG. 6 shows a front view of the chunk-cutter machine (1) in one embodiment, before the polymeric material (15) is cut by the first blade (6) in a horizontal plane.

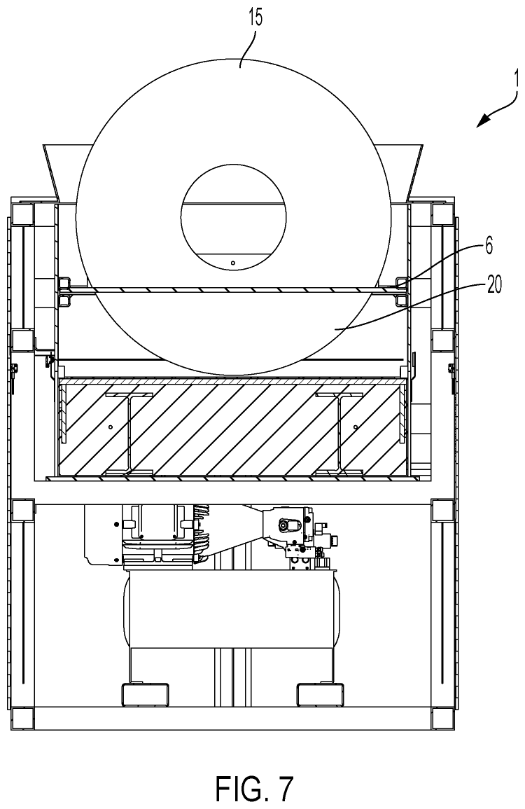

FIG. 7 shows a front view of the chunk-cutter machine (1) in one embodiment, after the polymeric material (15) is cut by the first blade (6) in a horizontal plane to form a portion of the polymeric material (20).

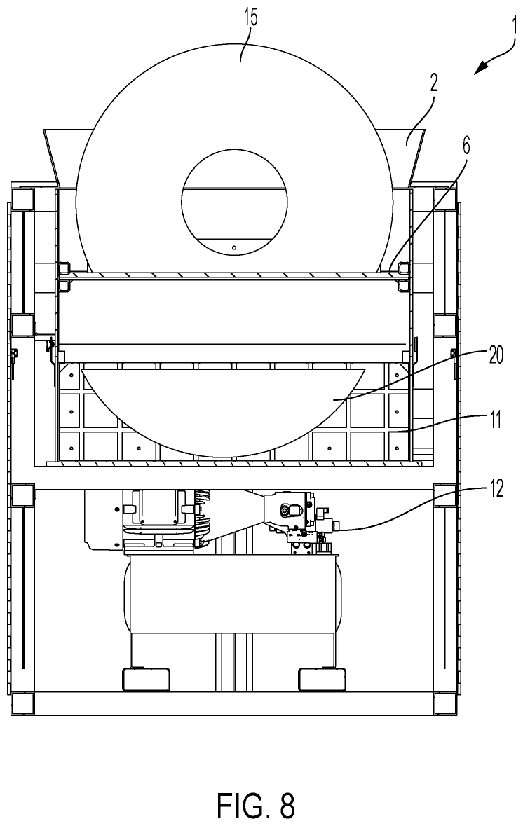

FIG. 8 shows a front view of the chunk-cutter machine (1) in one embodiment, where the freshly cut portion of the polymeric material (20), a tire-fill doughnut, is shown prior to it being cut into further chunks by hydraulic pressing by the hydraulic ram and the platen (11), and which is situated into the cavity formed by the hydraulic ram, the blade assembly (4) and the side walls of the chunk-cutter machine. Also, shown is the uncut portion of the tire-fill doughnut (15) sitting in the hopper (2) and above the plane of the horizontally-oriented first blade (6). In FIG. 8, the hydraulic machinery (12) has not yet been actuated to create hydraulic pressing or impact on the portion of the polymeric material, such as tire-fill or a polyurethane elastomeric material, trapping it between the vertically-oriented first wall of the hydraulic ram or platen (11) and the vertically-oriented plane of the blade assembly (4). In the next step, the hydraulic ram moves in the horizontal direction cutting the portion of the polymeric material, the tire-fill, into chunks of cubic shape, for example.

### Polymeric Material for Cutting

In some embodiments, the polymeric material used for cutting in the chunk-cutter machine can be any variety of polymers such as thermoplastic, thermosetting, cross-linked, IPN polymers, natural, synthetic and semi-synthetic polymers; elastomers; linear, branched, and cross-linked polymers; homopolymers and copolymers; fibers and liquid-crystalline polymers; biodegradable and conductive polymers, and the like. Stated differently, the polymeric material that can be shredded into chunks can be a polymer that can be categorized in one or more of the categories above. In a some embodiments, the polymeric material that can be cut by the chunk-cutter machine is an elastomeric polymeric material, such as an elastomeric polyurethane material. An example of an elastomeric polymeric material is polyurethane (PU) which includes thermoplastic or the thermosetting PU material, or both In some embodiments, the elastomeric PU material is a thermosetting material. In some embodiments, the PU material is a polyurethane foam material. For tire filling, the common foam used is a polyurethane liquid that cures into a flexible, durable elastomer core, replacing the air and eliminating flats, particularly in off-the-road (OTR) equipment. In some embodiments, the polymeric material is a tire-fill material. In some embodiments where the polymeric material is polyurethane material, the polymeric material includes blends, copolymers, and mixtures thereof. In some embodiments, the tire-fill material is the commercially available TyrFil® material from the Carlisle Co.

In some embodiments, the tire-fill material for cutting is obtained from used tires, unused tires, or other waste or non-waste material from tire-fill production, and other tire-fill operations. In some embodiment, the tire-fill material is for or from tires of OTR and heavy-duty equipment. In one embodiment, the tire-fill material is for or from tires usable for the following equipment: articulating boom aerial platforms; backhoes; baggage carts; carry-deck cranes; compact utility loaders; concrete buggies; forklifts; front-end loaders; GSE pushback tractors; mobile cranes; mowing equipment; personnel carriers; rough-terrain forklifts; scissor-lift aerial platforms; scoops; skid steers; shuttle cars; sweepers; tractors; trucks; telescopic aerial platforms; telehandler; trenchers; and wheel loaders.

### Feed Hopper for Feeding of the Polymeric Material to the Chunk-Cutter Machine

In some embodiments, the chunk-cutter machine further comprises a hopper for gravity-feeding or press-feeding the polymeric material. The hopper is generally vertically oriented, but it can also be angularly placed vis-à-vis the chunk-cutter machine to facilitate feeding of the polymeric material.

### Planar First Blade

In some embodiments, the chunk-cutter machine has a planar first blade that is capable of moving in a horizontal plane. This first blade is used to cut a portion of the polymeric material fed to the chunk-cutter machine through the hopper. The planar first blade is attached to a plunger which actuates the planar first blade. In some embodiments, the planar first blade moves in a horizontal direction once a portion of the polymeric material is lowered into the hopper and passes the plane of the planar first blade. The planar first blade moves horizontally slicing a portion of the polymeric material, such as a tire-fill doughnut. The portion of the polymeric material drops into the cavity formed by the blade assembly, the hydraulic ram, and the walls of the machine. The planar first blade is capable of moving in a nonhorizontal plane or in two or more different planes consecutively, depending on the size and the shape of the polymeric material that is to be cut. In some embodiments, the planar first blade has a constant cutting speed. In some embodiments, the planar first blade has a variable cutting speed and/or can move in a to-and-fro motion at a steady speed or at a variable speed. The polymeric material, such as tire-fill, is fed by gravity or can be pressed in from the top or from the sides to hold it in position for the planar first blade's cutting motion to be effectuated.

It should be noted that the chunk-cutter machine may not conduct an operation of cutting, with the planar first blade, the polymeric material if it is sufficiently small such that it can be fed directly to the cavity between the hydraulic ram and the blade assembly.

### Blade Assembly

The blade assembly of the chunk-cutter machine comprises a plurality of blades systematically organized into a pattern. In some embodiments, the blade assembly is vertically-oriented, which is perpendicular to the direction of movement of the hydraulic ram. This orientation allows the hydraulic ram's horizontal pressing to push the portion of the polymeric material into the blade assembly to derive the maximum force from the ram. The portion of the polymeric material is cut by pushing it through the blade assembly which cuts it into chunks. In some embodiments, the blade assembly is removably inserted and generally resides in a port or slot of the chunk-cutter machine on its front face. This facilitates replacement of the blade assembly when it becomes dull. In addition, this arrangement allows for a variety of blade shapes and sizes to be used. In some embodiments, the blade assembly is inserted from the side of the machine. In some embodiments, the blade assembly is comprised of cube-shaped slots that can cut a plurality of three-dimensional cube-shaped polymeric material chunks, for example, elastomeric polyurethane chunks from a tire-fill source, which is the polymeric material feed. In some embodiments, the blade assembly may have slots that are selected from square, rectangular, diamond, hexagonal, or circular, or 5 sided openings. The slots may not be all the same size or the same shape. In some embodiments, the walls of the openings of the blade assembly are sharp on both sides so that when one side becomes dull, the blade assembly may be flipped so present a new sharp side of the blade assembly to the hydraulic ram.

### The Hydraulic Ram and Hydraulic Machinery Means

In some embodiments, the hydraulic ram used for pressing the portion of the polymeric material for cutting into chunks has the dimension of its face that is substantially equal to or bigger than the size of the inner face of the blade assembly. In some embodiments, the hydraulic ram is three-dimensionally oriented in its shape, such as with a flat pressing surface. In some embodiments, the flat pressing surface of the hydraulic ram comprises a platen. The advancing face of the hydraulic ram, the blade assembly and the other two walls of the chunk-cutter machine form a cavity or a chamber or space where the portion of the polymeric material that has been previously cut with the first planar blade, or, if it is sufficiently small it may need no cutting by the planar blade. In some embodiments, the hydraulic ram is generally cuboid-shaped. In some embodiments, the hydraulic ram is predominantly a two-dimensional platen, with its third-dimension perpendicular to the blade but having only a nominal width compared to the other two dimensions of the platen. The hydraulic ram is capable of moving at a steady speed, at a variable speed, or in a to-and-fro motion, angular and horizontal motions that can go back and/or forth, and which can be steady or variable speed. The hydraulic ram is connected to a second plunger, which in turn is connected to the hydraulic machinery means or the hydraulic mechanism. The hydraulic machine means actuate the plunger, which, in turn, actuates the hydraulic ram to move it in an advancing or retracting direction to press or release pressing on the cut portion of the polymeric material against the blade assembly.

A hydraulic machine means for applying compressive force to the polymeric material is provided. The hydraulic machine means may include a hydraulic cylinder, piston, and compression head arranged to apply linear force, together with a hydraulic pump, valves, fluid lines, and associated structural mounts. The hydraulic cylinder is operable to advance the hydraulic ram toward the blade assembly so that the polymeric material is trapped and driven through the openings defined by the plurality of blades. In some embodiments, the hydraulic machine means is configured to drive the planar first blade to cut the polymeric material.

### Three-Dimensional Chunks of Polymeric Materials

In some embodiments, the blade assembly comprises a plurality of blades, which are shaped such that the resulting polymeric chunks have any one dimension in the range of 1 cm to 30 cm. For example, the 3-D chunks of the polymeric material have any one dimension selected from the following number or from a number selected from a range defined by any two numbers below, including the endpoints of such range, as measured in cm: 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30.

In some embodiments, the blade assembly, the blade shape and size result in the polymeric material having cubes or cuboid shapes (at least one dimension is different from the other two). In some embodiment, the blade assembly has the shape and size to result in cylinders, semi-cylinders, quarter-cylinders, discs, and other regular shapes, such as the prism shape, rectangular strips, pentagonal shapes, hexagonal shapes, and other geometric shapes. The blade assembly of the chunk-cutter also includes a mixed blade assembly with different sizes and shapes such that the three-dimensional chunks being cut include a variation of shapes and sizes.

### Method of Making Chunks From Polymeric Material Such as Tire-Fill

A method for preparing polymeric material chunks using the chunk-cutter machine, comprises providing polymeric material to the chunk-cutter machine; actuating a first planar blade that cuts a portion of the polymeric material, such as a tire-fill doughnut; actuating a hydraulic ram that presses the tire-fill type polymeric material vi-a-vis the blade assembly; and cutting such portion of the polymeric material into a plurality of chunks of a desired shape.

A method for preparing polymeric material chunks using the chunk-cutter machine comprises providing polymeric material to the chunk-cutter machine, using the planar first blade to cut a portion of the polymeric material, and cutting the portion of the polymeric material with the blade assembly to produce a plurality of chunks.

In some embodiments, the polymeric material is provided to the chunk-cutter machine by feeding through a hopper for gravity-feeding or press-feeding the polymeric material. The hopper is generally vertically oriented, but it can also be angularly placed vis-à-vis the chunk-cutter machine to facilitate feeding of the polymeric material as desired.

In some embodiments, the polymeric material used for cutting in the chunk-cutter machine can be any variety of polymers such as thermoplastic, thermosetting, cross-linked, IPN polymers, natural, synthetic and semi-synthetic polymers; elastomers; linear, branched, and cross-linked polymers; homopolymers and copolymers; fibers and liquid-crystalline polymers; biodegradable and conductive polymers, and the like. The polymeric material that can be shredded into chunks can be a polymer that can be categorized in one or more of the categories above. In some embodiments, the polymeric material that can be cut by the chunk-cutter machine is an elastomeric polymeric material. In some embodiments, the polymeric material is an elastomeric polyurethane material. In some embodiments, the elastomeric polymeric material is polyurethane (PU) including either thermoplastic or thermosetting PU material or both. In some embodiments, the elastomeric PU material is a thermosetting material. In some embodiments, the PU material is a polyurethane foam material. For tire filling, the common foam used is a polyurethane liquid that cures into a flexible, durable elastomer core, replacing the air and eliminating flats, particularly in off-the-road (OTR) equipment. In some embodiments, the polymeric material is a tire-fill material. In some embodiments, where the polymeric material is polyurethane material, it includes its blends, its copolymers, and mixtures thereof. In some embodiments, the tire-fill material is the commercially available TyrFil® material from the Carlisle Co.

In some embodiments, the tire-fill material for cutting is obtained from used tires, unused tires, or other waste or non-waste material from tire-fill production, and other tire-fill operations. In some embodiments, the tire-fill material is for or from tires of OTR and heavy-duty equipment. In some embodiments, the tire-fill material is for or from tires usable for the following equipment: articulating boom aerial platforms; backhoes; baggage carts; carry-deck cranes; compact utility loaders; concrete buggies; forklifts; front-end loaders; GSE pushback tractors; mobile cranes; mowing equipment; personnel carriers; rough-terrain forklifts; scissor-lift aerial platforms; scoops; skid steers; shuttle cars; sweepers; tractors; trucks; telescopic aerial platforms; telehandler; trenchers; and wheel loaders.

### Actuating the First Planar Blade

In some embodiments, the chunk-cutter machine has a planar first blade that is capable of moving in a horizontal plane. This first blade is used to cut a portion of the polymeric material fed to the chunk-cutter machine through the hopper. In some embodiments, the planar first blade moves in a horizontal direction once a portion of the polymeric material has been lowered into the hopper and passes the plane of the planar first blade. The planar first blade moves horizontally slicing the portion of the polymeric material, such as a tire-fill doughnut. The portion of the polymeric material drops into the cavity formed by the blade assembly, the hydraulic ram, and the walls of the machine. The planar first blade is capable of moving in a non-horizontal plane or in two or more different planes consecutively, depending on the size and the shape of the polymeric material that is to be cut. In some embodiments, the planar first blade has a constant cutting speed. In some embodiments, the planar first blade has a variable cutting speed or can move in a to-and-fro motion at a steady speed or at a variable speed. The polymeric material is fed by gravity or can be pressed from the top or from the sides to hold it in position for the planar first blade's cutting motion to be effectuated.

It should be noted that the chunk-cutter machine may not conduct an operation of cutting, with the planar first blade, the polymeric material if it is sufficiently small such that it can be fed directly to the cavity between the hydraulic ram and the blade assembly.

### Providing a Blade Assembly

In some embodiments, the blade assembly is removably inserted and generally resides in a port or slot of the chunk-cutter machine on its front face. This facilitates replacement of the blade assembly when it becomes dull. In addition, this arrangement allows for a variety of blade shapes and sizes to be used. The blade assembly of the chunk-cutter machine comprises a plurality of blades systematically organized into a pattern. In some embodiments, the blade assembly is vertically-oriented, which is perpendicular to the direction of movement of the hydraulic ram. This orientation allows the hydraulic ram's horizontal pressing to push the portion of the polymeric material into the blade assembly to derive the maximum force from the ram. The portion of the polymeric material is cut by pushing it through the blade assembly which cuts it into chunks. In some embodiments, the blade assembly is removably inserted and generally resides in a port or slot of the chunk-cutter machine on its front face. This facilitates replacement of the blade assembly when it becomes dull. In addition, this arrangement allows for a variety of blade shapes and sizes to be used. In some embodiments, the blade assembly is inserted from the side of the machine. In some embodiments, the blade assembly is comprised of cube-shaped slots that can cut a plurality of three-dimensional cube-shaped polymeric material chunks, for example, elastomeric polyurethane chunks from a tire-fill source, which is the polymeric material feed. In some embodiments, the blade assembly may have slots that are selected from square, rectangular, diamond, hexagonal, or circular, or 5 sided openings. The slots may not be all the same size or the same shape. In some embodiments, the walls of the openings of the blade assembly are sharp on both sides so that when one side becomes dull, the blade assembly may be flipped so present a new sharp side of the blade assembly to the hydraulic ram.

### Actuating the Hydraulic Ram Through the Hydraulic Machinery

In some embodiments, the hydraulic ram used for pressing the portion of the polymeric material for cutting into chunks has the dimension of its face that is substantially equal to or bigger than the size of the inner face of the blade assembly. In some embodiments, the hydraulic ram is three-dimensionally oriented in its shape, such as with a flat pressing surface. In some embodiments, the flat pressing surface of the hydraulic ram comprises a platen. The advancing face of the hydraulic ram, the blade assembly and the other two walls of the chunk-cutter machine form a cavity or a chamber or space where the portion of the polymeric material that has been previously cut with the first planar blade, or, if it is sufficiently small it may need no cutting by the planar blade. In some embodiments, the hydraulic ram is generally cuboid-shaped. In some embodiments, the hydraulic ram is predominantly a two-dimensional platen, with its third-dimension perpendicular to the blade but having only a nominal width compared to the other two dimensions of the platen. The hydraulic ram is capable of moving at a steady speed, at a variable speed, or in a to-and-fro motion, angular and horizontal motions that can go back and/or forth, and which can be steady or variable speed. The hydraulic ram is connected to a second plunger, which in turn is connected to the hydraulic machinery means or the hydraulic mechanism. The hydraulic machine means actuate the plunger, which, in turn, actuates the hydraulic ram to move it in an advancing or retracting direction to press or release pressing on the cut portion of the polymeric material against the blade assembly.

1. A chunk-cutter machine for cutting polymeric material, comprising:
(a) a planar first blade for cutting a portion of the polymeric material fed to the chunk-cutter machine;
(b) a first plunger arm actuatably connected to the planar first blade;
(c) a blade assembly for cutting the portion of the polymeric material into a plurality of three-dimensional chunks;
(d) a hydraulic ram, dimensionally compatible with the blade assembly such that the hydraulic ram can trap and press the portion of polymeric material for cutting through the plurality of blades of the blade assembly; and
(e) a second plunger actuatably connected to the hydraulic ram, which can actuate movement of the hydraulic ram.

2. The chunk-cutter machine of claim 1, further comprising a hopper for gravity-feeding or pressure-feeding the polymeric material.

3. The chunk-cutter machine of claim 1, wherein the planar first blade is capable of moving in a horizontal plane.

4. The chunk-cutter machine of claim 1, wherein the planar first blade has a variable cutting speed.

5. The chunk-cutter machine of claim 1, wherein the planar first blade can move in a to-and-fro motion.

6. The chunk-cutter machine of claim 1, further comprising a blade assembly slot, and wherein the blade assembly is removably inserted from the side of the machine into the blade assembly slot.

7. The chunk cutter machine of claim 1, wherein the blade assembly is comprised of cube-shaped slots that can cut a plurality of three-dimensional cube-shaped polymeric material chunks from the polymeric material feed.

8. The chunk-cutter machine of claim 1, wherein any one dimension of an opening blade assembly is in the range of 1 cm to 30 cm.

9. The chunk-cutter machine of claim 1, wherein the dimension of hydraulic ram's face used for pressurizing the portion of the polymeric material for cutting, is substantially equal to or bigger than the size of the inner face of the blade assembly.

10. The chunk-cutter machine of claim 1, wherein the hydraulic ram is a three-dimensional hydraulic ram.

11. The chunk-cutter machine of claim 1, wherein the hydraulic ram is predominantly a two-dimensional platen, with its third-dimension perpendicular to the blade but only having a nominal width compared to the other two dimensions of the platen.

12. The chunk-cutter machine of claim 1, wherein the hydraulic ram is capable of moving at a variable speed.

13. The chunk-cutter machine of claim 1, further comprising a hydraulic machinery means for actuating at least the hydraulic ram actuatably connected to the second plunger

14. A method for preparing polymeric material chunks using the chunk-cutter machine of claim 1, comprising:
providing polymeric material to the chunk-cutter machine,
using the planar first blade to cut a portion of the polymeric material, and
cutting the portion of the polymeric material with the blade assembly to produce a plurality of chunks.

15. The method for preparing polymeric material chunks of claim 14, wherein the polymeric material is an elastomeric polymeric material.

16. The method for preparing polymeric material chunks of claim 14, wherein the polymeric material is polyurethane material.

17. The method for preparing polymeric material chunks of claim 14, wherein the planar first blade moves in a horizontal plane.

18. The method for preparing polymeric material chunks of claim 14, wherein the planar first blade moves at a variable cutting speed.

19. The method for preparing polymeric material chunks of claim 14, wherein the hydraulic ram moves at a variable speed and/or in a to-and-fro motion.
